(19) United States
(12) Patent Application Publication
(10) Pub. No.: US 2024/0097318 A1
(43) Pub. Date: Mar. 21, 2024

(54) TRANSPARENT ANTENNA AND TOUCH DISPLAY ON A WEARABLE DEVICE

(71) Applicant: Meta Platforms Technologies, LLC, Menlo Park, CA (US)

(72) Inventors: Ce Zhang, Sunnyvale, CA (US); Chilin Hsu, San Jose, CA (US); Danyang Huang, San Jose, CA (US); Yasuo Morimoto, Cupertino, CA (US); Nengxiu Deng, Santa Clara, CA (US); Dong Chen, Kirkland, WA (US); Bruno Cendon Martin, Palo Alto, CA (US); Yonghua Wei, San Diego, CA (US); Jiang Zhu, Cupertino, CA (US); Geng Ye, Union City, CA (US)

(21) Appl. No.: 18/174,675

(22) Filed: Feb. 27, 2023

Related U.S. Application Data
(60) Provisional application No. 63/342,581, filed on May 16, 2022.

(51) Int. Cl. H01Q 1/38; G06F 3/044; H01Q 1/24

(52) U.S. Cl. CPC H01Q 1/38; G06F 3/0443; H01Q 1/243

(57) ABSTRACT

The disclosed devices and systems may include transparent antennas and touch displays that may be included in wearable devices. An example wearable device may include a display module including a display stack, the display stack including a display cover layer, an antenna layer, and a display layer, wherein the antenna layer (1) is positioned between the display cover layer and the display layer, and (2) includes at least one antenna element. Various other systems and devices are disclosed.

### CROSS-REFERENCE TO RELATED APPLICATION

This application claims the benefit of U.S. Provisional Patent Application No. 63/342,581, filed May 16, 2022, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 shows a perspective view of a wearable device having a display module in accordance with some embodiments described herein.

FIG. 2 shows a cross section view of a wearable device in accordance with some embodiments described herein.

FIG. 3 through FIG. 5 show various cross section views of display stacks that may include a transparent film with a printed transparent conductive material in accordance with some embodiments described herein.

FIG. 6 illustrates a cross section view of a transparent antenna film that includes meshed metal in accordance with some embodiments described herein.

FIG. 7 shows a comparison view of attributes of a meshed metal layer comprised of copper and having a 60 μm pitch versus a 120 μm pitch in accordance with some embodiments described herein.

FIG. 8 shows a diagram view of various components that may be included in and/or connected to a transparent antenna film as described herein.

FIG. 9 through FIG. 11 show views of an implementation of a display stack that includes a transparent antenna film as described herein.

FIG. 12 shows a cross section view of a multi-layer flexible printed circuit board in accordance with some embodiments described herein.

FIG. 13 through FIG. 15 show various cross section views of display stacks that may include a touch sensor layer that may include, incorporate, and/or implement a transparent antenna in accordance with some embodiments.

FIG. 16 shows a cross section view of a touch sensor film layer that may include, implement, and/or integrate a transparent antenna in accordance with some embodiments described herein.

FIG. 17 shows a side view of a display stack connected via a flexible printed circuit board to a printed circuit board in accordance with some embodiments described herein.

FIG. 18 shows a view of a touch sensor film layer that may be used for antenna radiation described herein.

FIG. 19 shows a view of an implementation of a touch sensor film layer that may be used for antenna radiation in accordance with some embodiments described herein.

FIG. 20 is an illustration of exemplary augmented-reality glasses that may be used in connection with embodiments of this disclosure.

FIG. 21 is an illustration of an exemplary virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Modern mobile electronic devices may implement many different types of antennas. To keep pace with the rapid evolution of wireless technology and the increasing user demands for ubiquitous wireless access, wearable electronic devices may support more and more wireless standards including, but not limited to, 3G/4G/5G, WiFi, global positioning system (GPS), Bluetooth, ultrawideband (UWB) and more. To enable multi-standard wireless connectivity, these wearable devices (e.g., smartwatches) may implement, integrate, or otherwise use several multi-band antennas within a relatively small form factor. In some cases, wearable electronic devices may implement antennas that use a metallic enclosure of the wearable device, for example, or use stamped metal or laser direct structuring (LDS) on a bottom face or cover of the wearable device to provide radiating surfaces for wireless functionality. In some cases, it may be difficult to implement additional antennas to cover further wireless standards, as space inside of a wearable device may be strictly limited.

One possible location for one or more antennas may be a display region of the wearable device. Antennas, however, are typically made of opaque conductive material. As such, adding an antenna trace onto the display could create visible defects that may negatively affect user experience. Still further, display quality and display resolution are paramount to a positive user experience. As such, antenna implementations should not detract from the display experience. Moreover, displays are highly complex and involve multiple delicately structured layers including cover glass, adhesive layers, polarizers, encapsulation layers, touch sensors, cathodes, organic light emitting diodes (OLEDs), anodes, and substrate layers. Thus, adding additional components to display layers may introduce reliability issues in addition to any defects that may be visible in the display. Hence, the current application identifies and addresses a need for improved integration of antennas into wearable devices.

This application is directed to various devices and systems that may integrate antennas into touch displays of wearable devices. In some embodiments disclosed herein, an antenna may be implemented on a transparent thin film embedded in a display module for a mobile electronic device (e.g., a smartwatch). Different implementations are provided herein that involve different technologies. In one embodiment, an antenna may be provided on a separate antenna film that is disposed within in the display stack. In such an embodiment, two (or more) closely spaced multiple input multiple output (MIMO) antennas with multiple feed ports may be implemented on a separate transparent film and may be attached to an interior surface (e.g., bottom) of a cover layer in the display module. An antenna trace of this embodiment may be formed using a conductive meshed metal (e.g., copper) layer on the transparent film.

In another embodiment, a touch sensor film layer may be used for antenna radiation. A “fish bone” shaped antenna may be implemented on the touch sensor film layer. In such cases, the antenna traces may be designed to run along gaps that may exist between touch pads on a conductive touch sensor layer. In such cases, the antenna traces may be coplanar with the touch sensing pads. The fish bone antenna trace structure may be routed along the gaps between touch sensing pads. The conductive touch sensor layers may be implemented with indium tin oxide (ITO) or silver nano-ware (SNW).

In one embodiment, a system may be provided that includes a display cover layer and a transparent antenna film layer that includes a film layer having one or more antennas. The transparent antenna film layer may be positioned between the display cover layer and one or more display layers. In some cases, the transparent antenna film layer may include printed transparent conductive material. This transparent printed conductive material may include meshed metal. In some cases, the meshed metal may be provided at different levels of pitch, including 60 μm, 120 μm, or other pitch levels. The meshed metal on the transparent antenna film layer may be transparent to human eyes.

In some embodiments, the system may further include an adhesive layer and a substrate layer. In such cases, the transparent antenna film layer of the system may be disposed on top of the adhesive layer, which itself is disposed on top of the substrate layer. The system may also include a multi-layer flex that connects a radio frequency (RF) signal from an RF integrated circuit (RFIC) to the transparent antenna film layer. The transparent antenna film layer may include MIMO antennas. These antennas may be substantially any type of antennas, including monopole, dipole, loop, slot, or other types of antennas. Moreover, the antennas may include any type of associated radio including a cellular radio, a global positioning system (GPS) radio, a WiFi radio, a Bluetooth radio, a near-field communication (NFC) radio, an ultrawideband (UWB) radio, or other type of radio.

In another embodiment, a system may be provided that includes a conductive touch sensor layer including a plurality of touch sensor elements, a substrate layer, and a conductive antenna layer that itself includes one or more radiating antenna traces. The substrate layer may separate the conductive touch sensor layer from the conductive antenna layer. And, in this system, the radiating antenna traces of the conductive antenna layer may be routed between the plurality of touch sensor elements. In some cases, this system may further include a flex printed circuit to which at least a portion of the substrate layer may be bound. The flex printed circuit may electrically connect the conductive touch layer to a touch sensing integrated circuit and may connect the conductive antenna layer to an RFIC. In some cases, the radiating antenna traces of the conductive antenna layer may be disposed in a fish-bone pattern within one or more gaps between touch sensor elements.

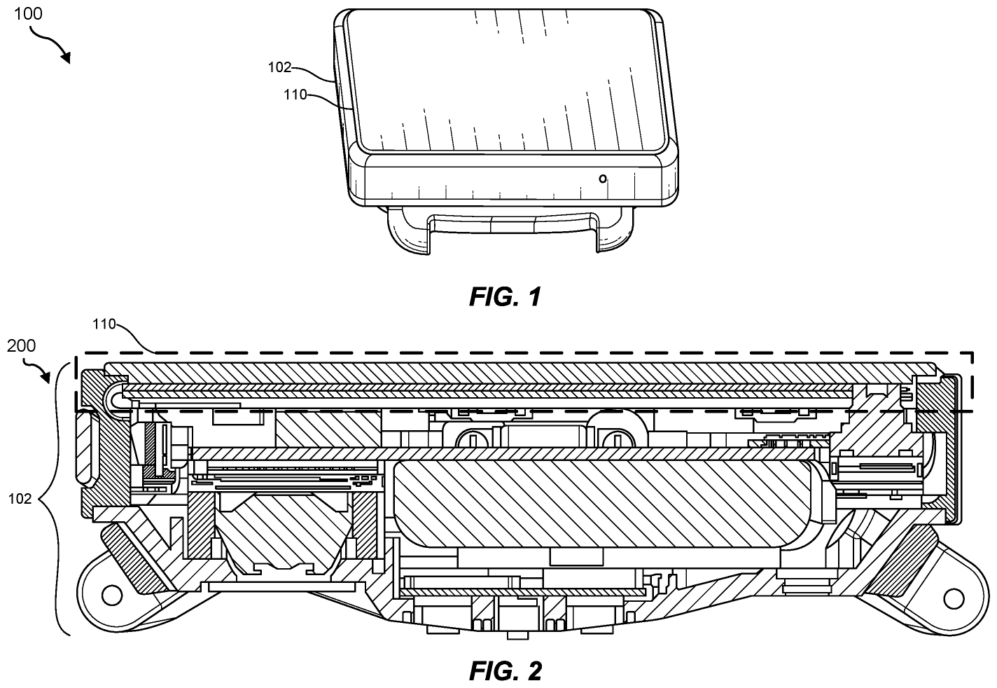

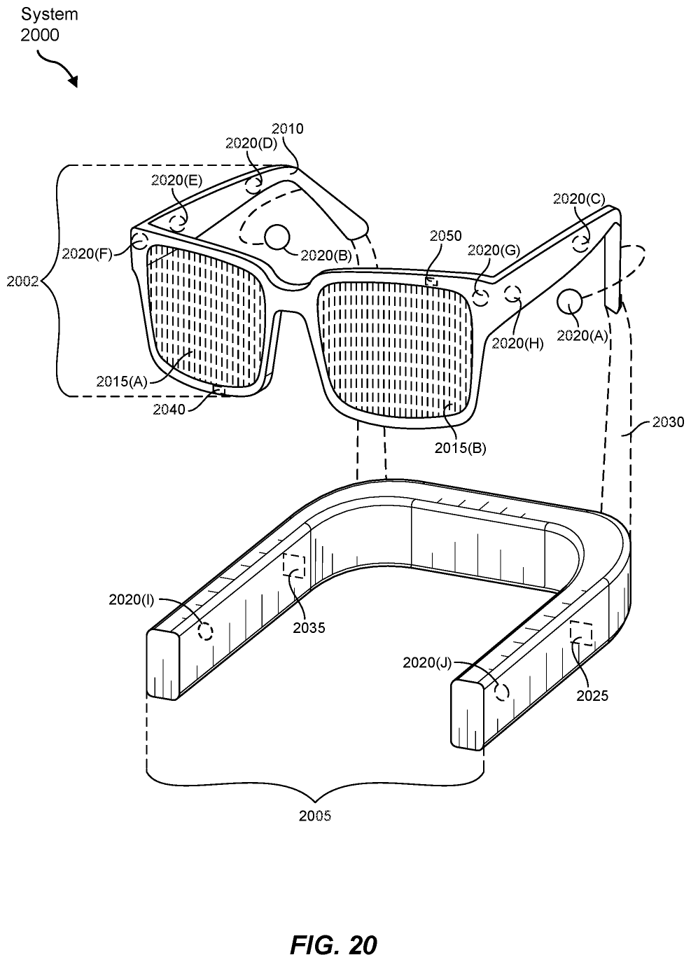

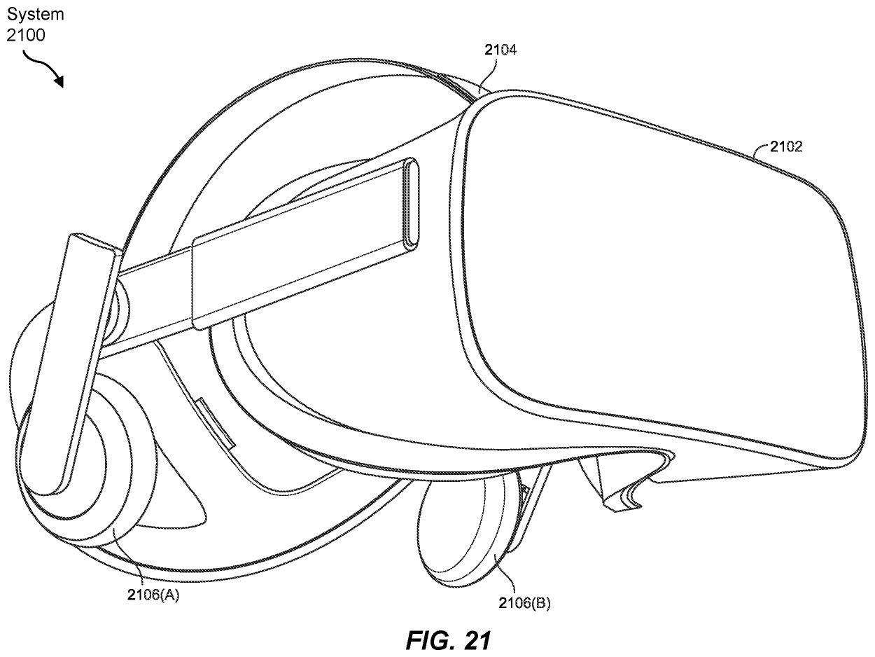

The following will provide, with reference to FIGS. 1-19, detailed descriptions of devices and systems for improving antenna performance for wearable devices having touch displays via transparent antennas included in touch displays. Additionally, detailed descriptions of one or more artificial reality systems that may incorporate embodiments of one or more of the devices and/or systems described herein will be provided in connection with FIGS. 20-21.

FIG. 1 shows a perspective view 100 of a wearable device 102 having a display module 110. Although wearable device 102 may be referred to herein as a smart watch, this is not intended to limit the scope of this disclosure in any way. Indeed, it may be observed that embodiments of the devices and systems described herein may be included and/or incorporated into any device that may include a suitable display module and/or touch display.

FIG. 2 shows a cross section view 200 of wearable device 102. As shown, at least a portion of display module 110 is disposed on and/or forms a face of wearable device 102 and is positioned such that, when wearable device 102 is worn by a user, display module 110 may be accessible to and/or viewable by the user.

As mentioned above, in some examples, a transparent film with a printed transparent conductive material may be included as part of (e.g., placed within, disposed upon a layer of, included as a layer of, etc.) a stackup of a display module (also referred to herein as a “display stack”). The transparent film may be positioned between one or more layers of the display stack. For example, the film may be positioned between a top cover (e.g., a lens cover, a display cover, a glass layer, etc.) that may form an exterior layer of the display stack and an optically clear adhesive (OCA) layer.

In general, a display stack or “stackup” may include a top layer (often referred to as an overlay, cover lens, or cover glass), conductive elements (e.g., sensors, vias, ground/shielding entities, traces, etc.), and a printed circuit board (PCB) layer. A touch-enabled display stack or touch panel may include a touch sensor and one or more touch sensor electrodes. Touch-enabled displays may be classified according to a relative location of a touch sensor within the display stack. An “in-cell” type touch panel may include a touch sensor integrated inside of or in between other layers in the display stack that may provide display functions. An “on-cell” type touch panel may include a touch sensor on top of a display layer, such as a liquid crystal display (LCD) layer or an organic light emitting diode (OLED) display layer. An “out-cell” or “add-on” type touch panel may include a touch sensor outside of a display and may be separated from other portions of the display stack (e.g., by an air gap).

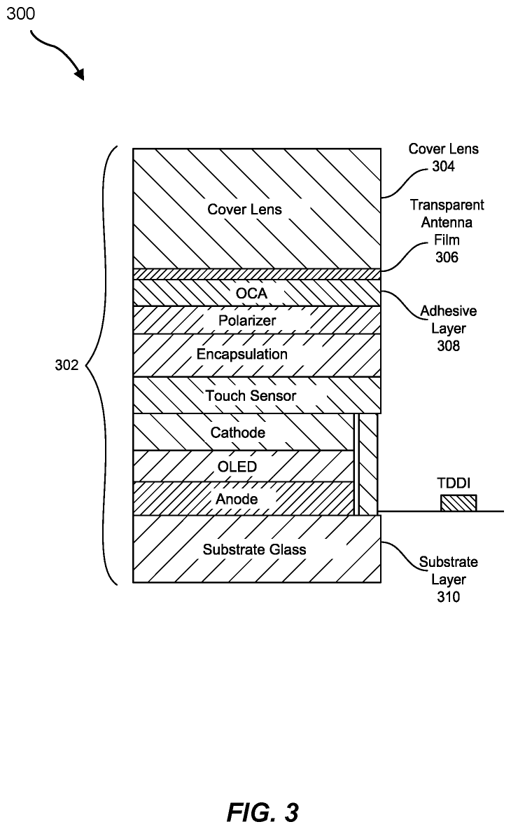

FIG. 3 through FIG. 5 show various cross section views of display stacks that may include a transparent film with a printed transparent conductive material. In FIG. 3, cross section view 300 shows a cross section of a display module 302 having an in-cell touch sensor configuration. As shown, display module 302 includes a cover lens 304, a transparent antenna film 306, and an adhesive layer 308. In this example, transparent antenna film 306 is disposed between cover lens 304 and adhesive layer 308. In some examples, adhesive layer 308 may include or be part of an OCA layer. Display module 302 in FIG. 3 includes many additional layers including a polarizer layer, a touch sensor layer, an encapsulation layer, a cathode layer, an organic light emitting diode (OLED) layer, and an anode layer. As shown in the example of FIG. 3, the foregoing layers may be disposed upon a substrate layer 310 that may, in some examples, include and/or be referred to as a substrate glass.

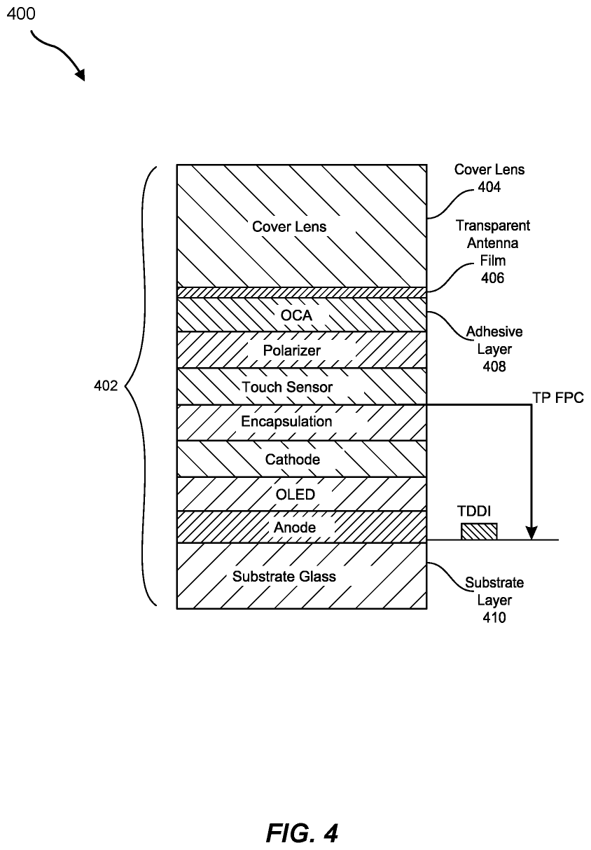

FIG. 4 includes a cross section view 400 that shows a cross section of a display module having an on-cell touch sensor configuration. As shown, display module 402 includes a cover lens 404, a transparent antenna film 406, and an adhesive layer 408. In this example, transparent antenna film 406 is disposed between cover lens 404 and adhesive layer 408. In some examples, adhesive layer 408 may include or be part of an OCA layer. Display module 402 in FIG. 4 includes many additional layers including a polarizer layer, a touch sensor layer, an encapsulation layer, a cathode layer, an organic light emitting diode (OLED) layer, and an anode layer. As shown in the example of FIG. 4, the foregoing layers are disposed upon a substrate layer 410 that may, in some examples, include and/or be referred to as a substrate glass. As will be described in greater detail below, as shown in the example illustrated by FIG. 4, in some examples, a touch sensor may be communicatively coupled to a controller via a flexible printed circuit (FPC) connector (“TP FPC” in FIG. 4). In some examples, the controller may be referred to as a “touch controller and display driver integration” or “TDDI.”

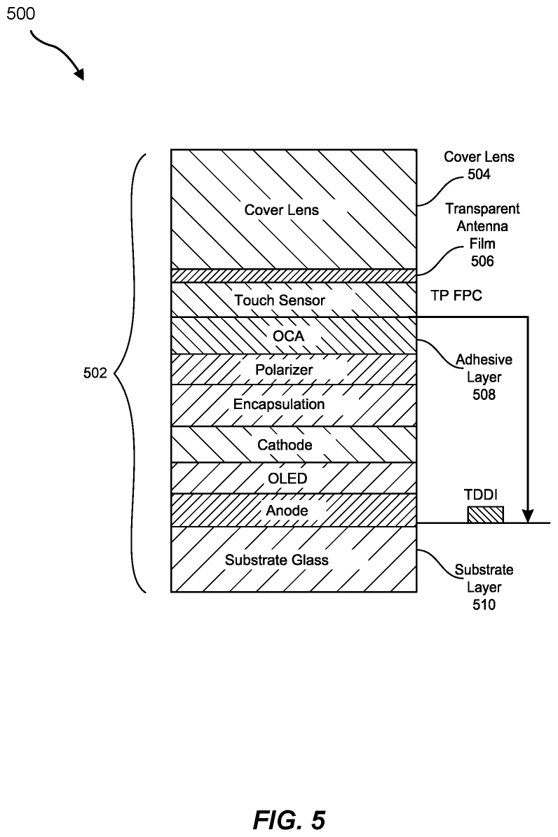

FIG. 5 includes a cross section view 500 that shows a cross section of a display module having an on-cell touch sensor configuration. As shown, display module 502 includes a cover lens 504, a transparent antenna film 506, and an adhesive layer 508. In this example, transparent antenna film 506 is disposed between cover lens 504 and adhesive layer 508. In some examples, adhesive layer 508 may include or be part of an OCA layer. Display module 502 in FIG. 5 includes many additional layers including a polarizer layer, a touch sensor layer, an encapsulation layer, a cathode layer, an organic light emitting diode (OLED) layer, and an anode layer. As shown in the example of FIG. 5, the foregoing layers are disposed upon a substrate layer 510 that may, in some examples, include and/or be referred to as a substrate glass. As in FIG. 4, the touch sensor in FIG. 5 may be communicatively coupled to a TDDI via a FPC connector (“TP FPC” in FIG. 5).

As mentioned above, in some examples, a transparent antenna film layer (e.g., transparent antenna film 306, transparent antenna film 406, transparent antenna film 506, etc.) may include a meshed metal. The meshed metal may include any suitable metal and/or metal alloy including, without limitation, meshed copper.

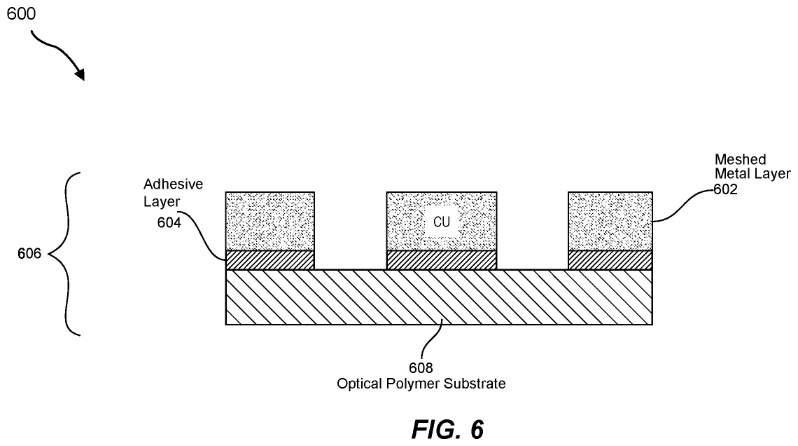

In some examples, a meshed metal or meshed metal layer that may be included as a part of a transparent antenna film layer may include a plurality of components or layers. FIG. 6 illustrates a cross section view 600 of a transparent antenna film 606 that includes meshed metal. As shown, transparent antenna film 606 includes three layers: a meshed metal layer 602, an adhesive layer 604, and an optical substrate layer 608. In some examples, meshed metal layer 602 may be coupled and/or attached to optical substrate layer 608 via adhesive layer 604.

In some examples, meshed metal layer 602 may be comprised of metal (e.g., copper) wire arranged or formed into a mesh, which may have a predetermined pitch. A pitch of a wire mesh may refer to a measurement of a distance between midpoints of two adjacent wires that form a part of the wire mesh. Hence, a wire mesh where the midpoints of two wires forming the mesh are 1 μm apart may be referred to as a wire mesh having a pitch of 1 μm.

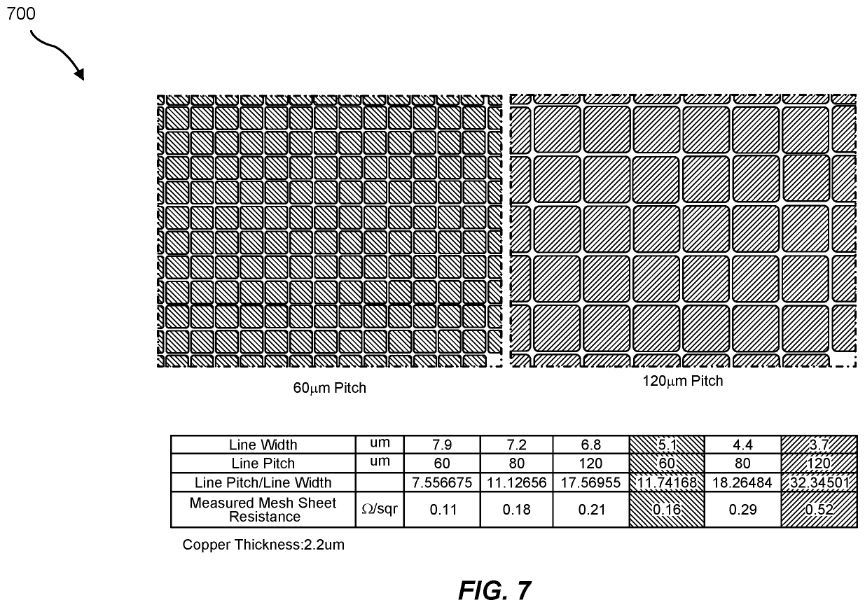

Attributes of a meshed metal layer may impact a resistance (e.g., a sheet resistance) of the meshed metal layer as well as an optical transparency of the meshed metal layer. FIG. 7 shows a comparison view 700 of attributes of a meshed metal layer comprised of copper and having a 60 μm pitch versus a 120 μm pitch. As shown, a meshed line width/pitch may be design parameters that may impact sheet resistivity, antenna radiation efficiency, and optical transparency. A careful choice of these design parameters may impact user experience of a display that includes a transparent antenna film layer of this kind as well as potential for use in wireless connectivity applications. Hence, in some examples, a transparent antenna film layer may include a meshed metal. In further examples, the meshed metal may have a predefined pitch of up to or at least 60 μm. In additional or alternative examples, the meshed metal may have a pitch of up to or at least 120 μm.

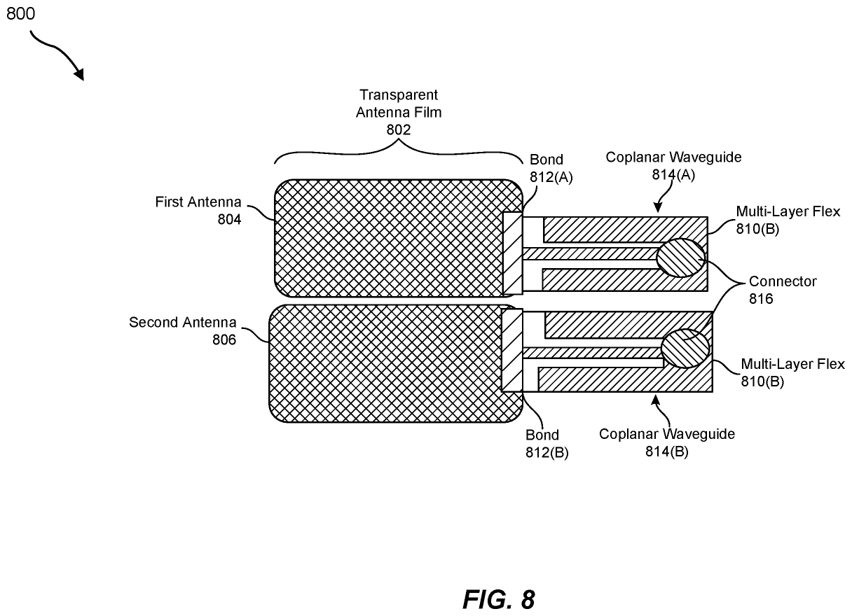

Example implementations of a touch-sensitive display modules that include a transparent antenna film layer will now be described in reference to FIGS. 8-12.

FIG. 8 shows a diagram view 800 of various components that may be included in and/or connected to a transparent antenna film as described herein. As shown, a transparent antenna film may include at least one meshed metal antenna. In the example shown in FIG. 8, transparent antenna film 802 includes a first antenna 804 and a second antenna 806. First antenna 804 and second antenna 806 may be included as part of a conductive region for a transparent antenna film layer (e.g., transparent antenna film 306, transparent antenna film 406, transparent antenna film 506, etc.) and may each be comprised of meshed metal (e.g., meshed copper). In this example, first antenna 804 and second antenna 806 may be implemented as a MIMO antenna on the same transparent antenna film layer.

In this example, first antenna 804 and second antenna 806 are each connected to a multi-layer flexible printed circuit board (“multi-layer flex 810”) via a bond 812. First antenna 804 is connected to multi-layer flex 810(A) via bond 812(A) and second antenna 806 is connected to multi-layer flex 810(B) via bond 812(A). Each of bonds 812 may include any suitable bonding agent such as, without limitation, an anisotropic conductive film (ACF) or similar conductive adhesive.

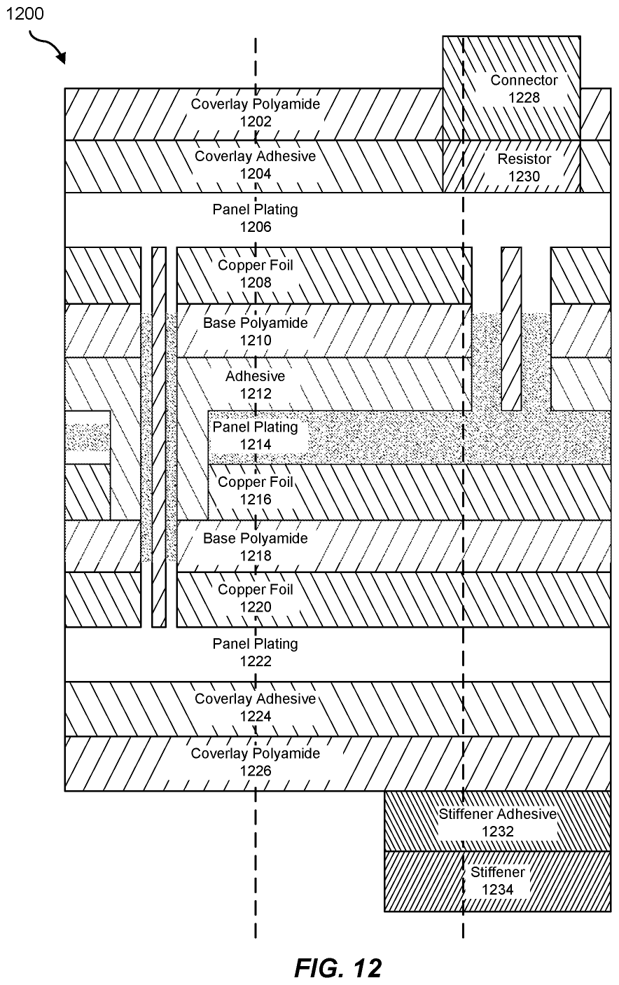

As will be described in greater detail below in reference to FIG. 12, a multi-layer flex such as multi-layer flex 810 may include a plurality of layers and other components that may facilitate transfer of RF signals from and/or to a transparent antenna film layer. Each multi-layer flex 810 may communicatively couple and/or connect an antenna to a control device and may conduct RF signals from and/or to an RFIC included in the control device. In the example shown in FIG. 8, each multi-layer flex 810 may include a corresponding coplanar waveguide 814 (e.g., multi-layer flex 810(A) may include a coplanar waveguide 814(A) and multi-layer flex 810(B) may include a coplanar waveguide 814(B)). Coplanar waveguides 814 may conduct and/or may facilitate conduction of RF signals from and/or to transparent antenna film 802 and/or corresponding portions thereof. In the example shown in FIG. 8, coplanar waveguide 814(A) may conduct and/or may facilitate conduction of RF signals from and/or to first antenna 804 and coplanar waveguide 814(B) may conduct and/or may facilitate conduction of RF signals from and/or to second antenna 806. Multi-layer flex 810(A) and/or multi-layer flex 810(B) may be connected to another component (e.g., a control device) via a suitable connector 816.

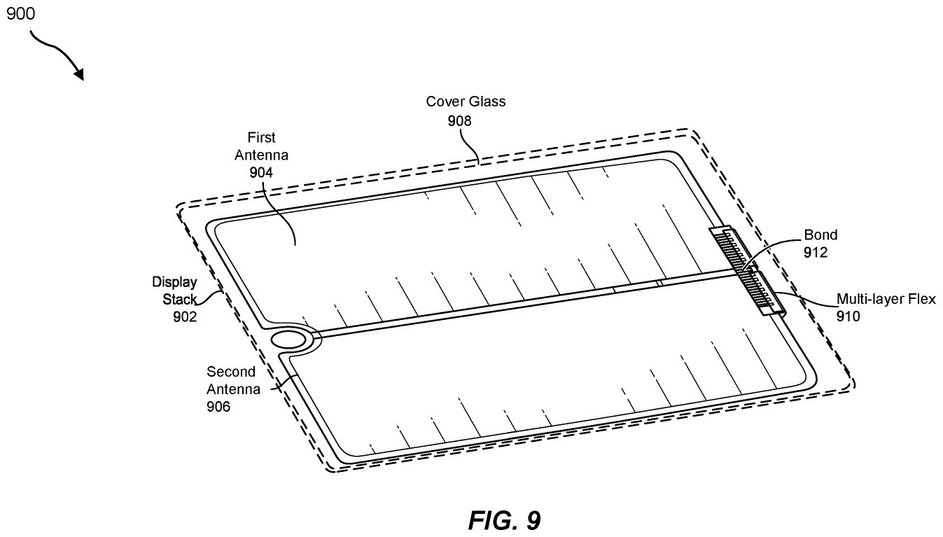

FIGS. 9-11 show various views of a display stack that includes a touch-sensitive display module that includes a transparent antenna film layer. FIG. 9 shows a perspective view 900 of a display stack 902. Display stack 902 may be a touch-enabled display stack that also includes a transparent antenna film layer. The transparent antenna film layer may include a first antenna 904 and a second antenna 906 disposed and/or fixed beneath a cover glass 908. First antenna 904 and second antenna 906 may be included as part of a conductive region for a transparent antenna film layer and may be comprised of meshed metal (e.g., copper). In this example, first antenna 904 and second antenna 906 may be implemented as a MIMO antenna on the same transparent antenna film layer. In this example, first antenna 904 and second antenna 906 are connected to a multi-layer flexible printed circuit board (“multi-layer flex 910”) via a bond 912. Bond 912 may include any suitable bonding agent such as, without limitation, an ACF or similar conductive adhesive.

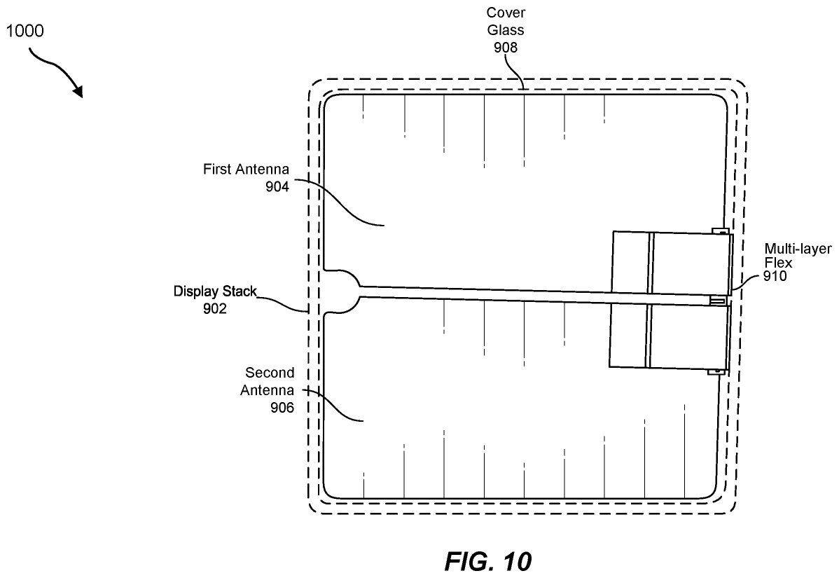

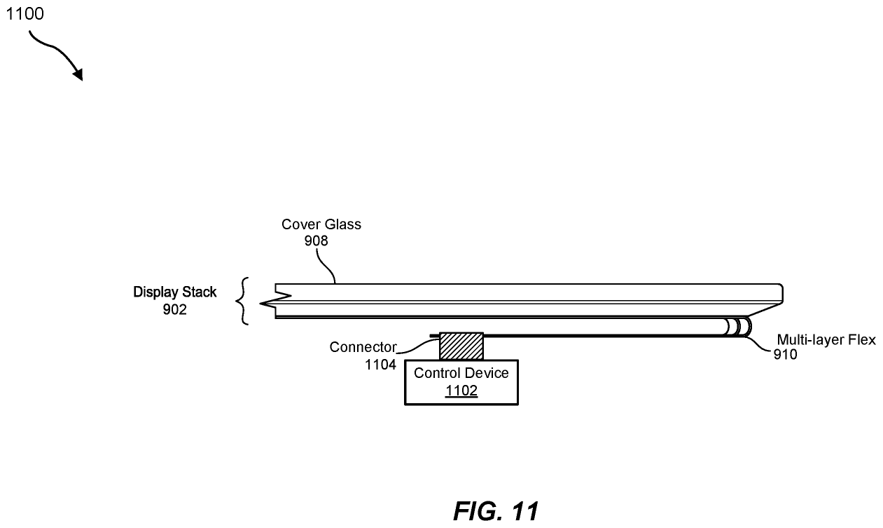

FIG. 10 shows a top view 1000 of display stack 902 that also includes first antenna 904, second antenna 906, cover glass 908, and multi-layer flex 910. FIG. 11 shows a side view 1100 of display stack 902. In this view, multi-layer flex 910 is also shown connecting display stack 902 (e.g., one or more components included in display stack 902, such as first antenna 904 and/or second antenna 906) to a control device 1102 via a connector 1104. In some examples, control device 1102 may include an RFIC (e.g., a PCB that includes an RFIC) and/or a TDDI (e.g., a PCB that includes a TDDI).

As mentioned above, a multi-layer flexible printed circuit board (e.g., multi-layer flex 810, multi-layer flex 910, etc.) may include a plurality of layers and other components that may facilitate transfer of RF signals from and/or to a transparent antenna film layer. FIG. 12 shows a diagram view 1200 of a side view of a multi-layer flexible printed circuit board in accordance with some embodiments described herein. As shown, in general, a multi-layer flexible printed circuit board may include three groups of layers: conductive layers, adhesive layers, and dielectric substrate layers. Conductive layers in FIG. 12 may include copper foil layers (e.g., copper foil 1208, copper foil 1216, and copper foil 1220) and plating layers (e.g., panel plating 1206, panel plating 1214, and panel plating 1222). Adhesive layers may include coverlay adhesive 1204, adhesive 1212, and coverlay adhesive 1224. Dielectric layers may include coverlay polyamide 1202, base polyamide 1210, base polyamide 1218, and coverlay polyamide 1226.

In some examples, the conductive layers (e.g., base polyamide 1210 and/or base polyamide 1218) may be used to implement a coplanar waveguide (e.g., coplanar waveguide 814(A) and/or coplanar waveguide 814(B)) for conducting RF signals. In some examples, copper foil 1208 and/or copper foil 1220 may be used for RF ground shielding.

Connector 1228 may connect the multi-layer flexible printed circuit board to another component (e.g., a control device such as control device 1102). Resistor 1230 may include and/or be referred to as a shunt resistor and may be used to measure and/or control an electrical current that passes through connector 1228. Stiffener adhesive 1232 may cause Stiffener 1234 to adhere to overlay polyamide 1226. Stiffener 1234 may include any suitable stiffening material including, without limitation, a polyamide stiffener and/or a stainless-steel stiffener.

As mentioned above, in some examples, a “fish bone” shaped antenna may be implemented on a touch sensor film layer. In such cases, the antenna traces may be designed to run along gaps that may exist between touch pads on a conductive touch sensor layer. The antenna traces may, in some examples, be coplanar with the touch sensing pads, with the fish bone antenna trace structure routed along gaps between touch sensing pads.

Hence, in some embodiments, a conductive touch sensor layer may include a plurality of touch sensor elements, a substrate layer, and a conductive antenna layer that itself includes one or more radiating antenna traces. The substrate layer may separate the conductive touch sensor layer from the conductive antenna layer and radiating antenna traces of the conductive antenna layer may be routed between the plurality of touch sensor elements. In at least some embodiments, radiating antenna traces of the conductive antenna layer may be disposed in a fish bone pattern within one or more gaps between touch sensor elements.

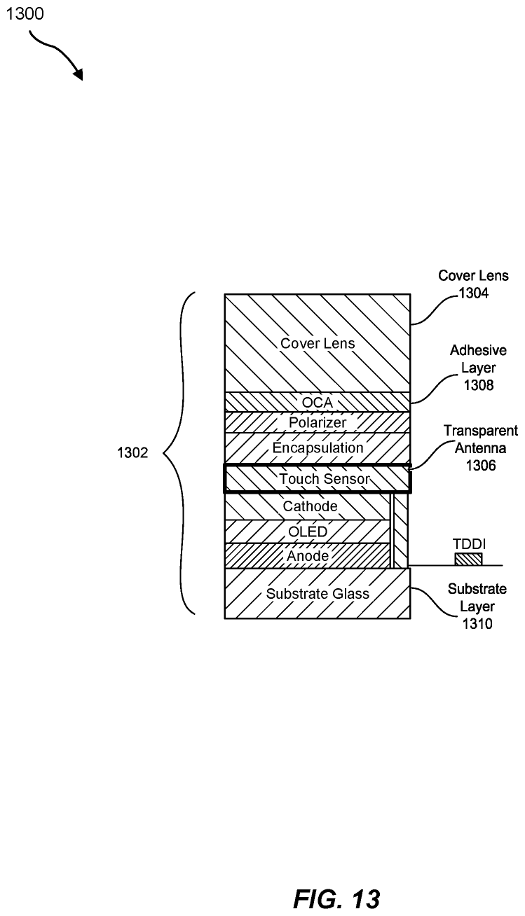

As discussed above in reference to FIG. 3 through FIG. 5, touch-enabled displays may be classified according to a relative location of a touch sensor within the display stack. FIG. 13 through FIG. 15 show various cross section views of display stacks that may include a touch sensor layer that may include, incorporate, and/or implement a transparent antenna in accordance with some embodiments.

In FIG. 13, cross section view 1300 shows a cross section of a display module 1302 having an in-cell touch sensor configuration. As shown, display module 1302 includes a cover lens 1304, a transparent antenna 1306, and an adhesive layer 1308. In this example, transparent antenna 1306 is disposed within and/or included as part of a touch sensor layer. In some examples, adhesive layer 308 may include or be part of an OCA layer. Display module 1302 in FIG. 3 includes many additional layers including a polarizer layer, an encapsulation layer, a cathode layer, an organic light emitting diode (OLED) layer, and an anode layer. As shown in the example of FIG. 3, the foregoing layers may be disposed upon a substrate layer 1310 that may, in some examples, include and/or be referred to as a substrate glass.

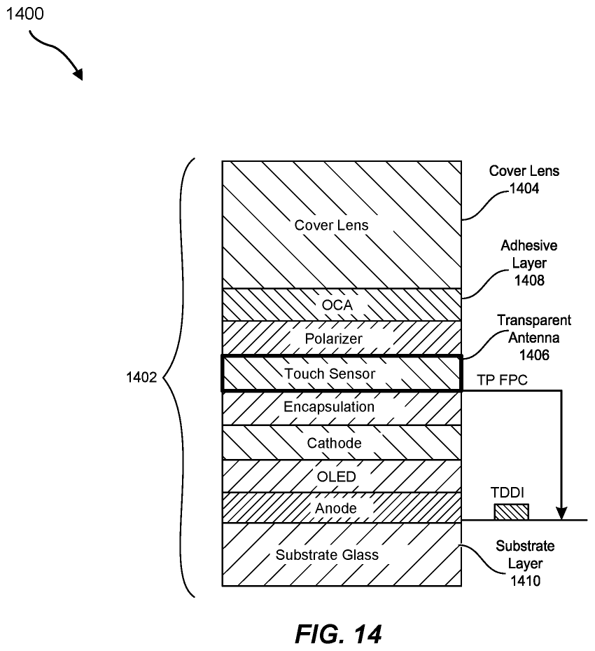

FIG. 14 includes a cross section view 1400 that shows a cross section of a display module having an on-cell touch sensor configuration. As shown, display module 1402 includes a cover lens 1404, a transparent antenna 1406, and an adhesive layer 1408. In this example, transparent antenna 1406 is disposed within and/or included as part of the touch sensor layer. In some examples, adhesive layer 408 may include or be part of an OCA layer. Display module 1402 in FIG. 4 includes many additional layers including a polarizer layer, an encapsulation layer, a cathode layer, an organic light emitting diode (OLED) layer, and an anode layer. As shown in the example of FIG. 14, the foregoing layers are disposed upon a substrate layer 1410 that may, in some examples, include and/or be referred to as a substrate glass. As will be described in greater detail below, as shown in the example illustrated by FIG. 4, in some examples, a touch sensor may be communicatively coupled to a controller or TDDI via a FPC connector (“TP FPC” in FIG. 14).

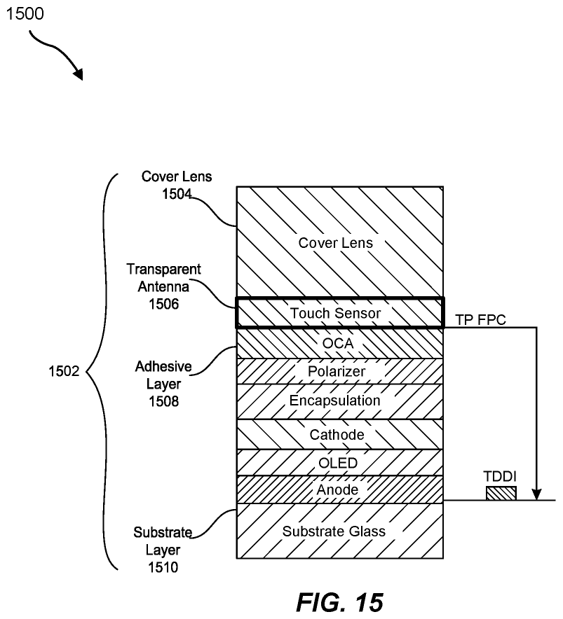

FIG. 15 includes a cross section view 1500 that shows a cross section of a display module having an on-cell touch sensor configuration. As shown, display module 1502 includes a cover lens 1504, a transparent antenna film 1506, and an adhesive layer 1508. In this example, transparent antenna film 506 is disposed within and/or included as part of a touch sensor layer disposed between cover lens 1504 and adhesive layer 1508. In some examples, adhesive layer 1508 may include or be part of an OCA layer. Display module 1502 in FIG. 15 includes many additional layers including a polarizer layer, an encapsulation layer, a cathode layer, an organic light emitting diode (OLED) layer, and an anode layer. As shown in the example of FIG. 15, the foregoing layers are disposed upon a substrate layer 1510 that may, in some examples, include and/or be referred to as a substrate glass. As in FIG. 14, the touch sensor in FIG. 15 may be communicatively coupled to a TDDI via a FPC connector (“TP FPC” in FIG. 15).

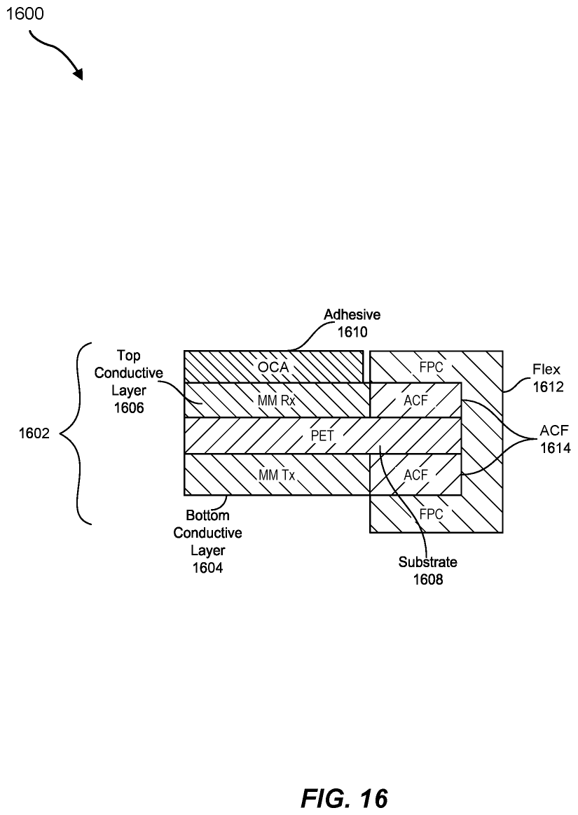

In some examples, a touch sensor may include a conductive layer that may be reused for implementation of an antenna. FIG. 16 shows a cross section view 1600 of a cross section of a touch sensor film layer 1602 that may include, implement, and/or integrate a transparent antenna in accordance with some embodiments. As shown, touch sensor film layer 1602 may include a bottom conductive layer 1604, top conductive layer 1606, a substrate layer 1608, one or more adhesives 1610, a flexible printed circuit board 1612 (“Flex 1612” in FIG. 16), and one or more portions of ACF (“ACF 1614” in FIG. 16).

In this example, bottom conductive layer 1604 and top conductive layer 1606 may each be made of a micro mesh (MM) material that may include a conductive material (e.g., copper). Bottom conductive layer 1604 may be configured to transmit (Tx) a signal or current to top conductive layer 1606 through or via substrate layer 1608. Likewise, top conductive layer 1606 may be configured to receive (Rx) a signal or current from bottom conductive layer 1604 through or via substrate layer 1608. Substrate layer 1608 may be made of any suitable material such as, without limitation, a polyester (PET) material. Adhesive 1610 may include any suitable optically clear adhesive and may be used to attach touch sensor film layer 1602 to one or more other layers within a display stack. ACF 1614 may be used to connect touch sensor film layer 1602 to flexible printed circuit board 1612.

Top conductive layer 1606 may include and/or implement one or more touch pads and/or one or more traces that may connect one or more touch pads to one or more touch sensing integrated circuits (e.g., a TDDI). Bottom conductive layer 1604 may be used to implement one or more antennas.

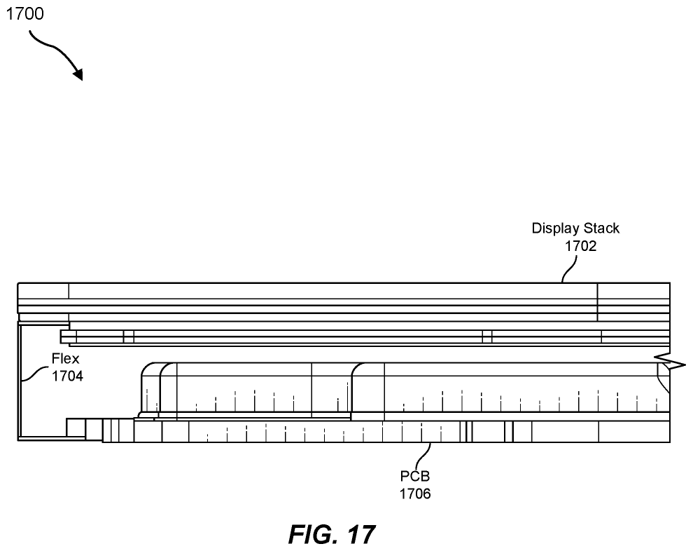

FIG. 17 shows a view 1700 of a side view of a display stack 1702 connected via a flexible printed circuit board 1704 (“Flex 1704” in FIG. 17) to a printed circuit board 1706 (“PCB 1706” in FIG. 17). Although not shown in FIG. 17, printed circuit board 1706 may include and/or implement a control device that includes and/or implements a RFIC and/or a TPIC and/or a TDDI.

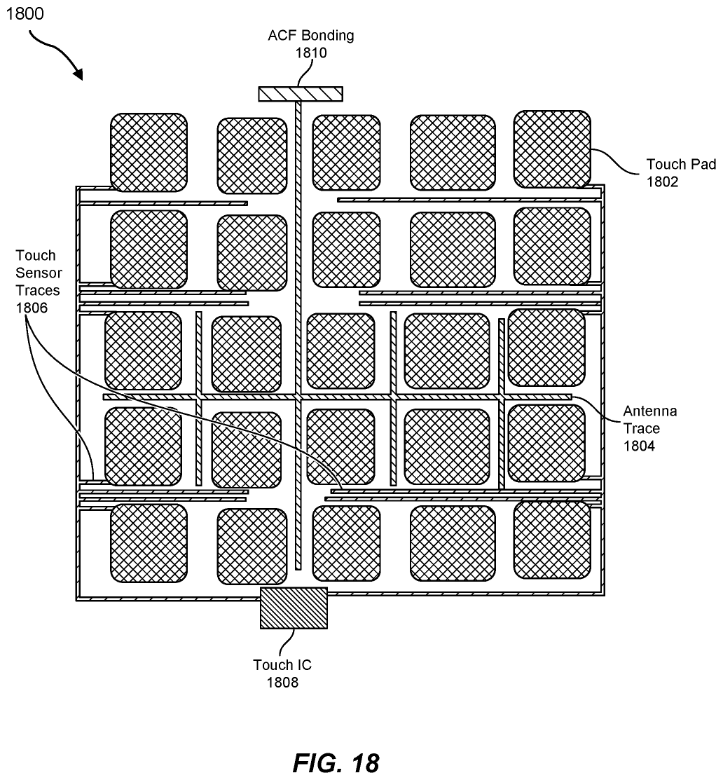

FIG. 18 shows a view of a touch sensor film layer 1800 that may be used for antenna radiation. As shown, touch sensor film layer 1800 includes at least one touch pad 1802, with twenty-five touch pads total shown in FIG. 18. Touch sensor film layer 1800 also includes an antenna trace 1804 that includes traces that run along gaps between the touch pads. In some examples, antenna trace 1804 may be said to have a ‘fish bone” shape. As shown, antenna trace 1804 may be coplanar with the touch sensing pads (e.g., touch pad 1802). As mentioned above, in some examples, the conductive touch sensor layers may be implemented with ITO or SNW.

Touch sensor traces 1806 may connect touch pads (e.g., touch pad 1802) to a touch IC 1808. In some examples, touch sensor traces 1806 may be routed along a gap between touch pads and a bezel of a display stack that includes touch sensor film layer 1800. Touch sensor traces 1806 may be merged to a bus of signal lines and may be connected to a multi-lane analog-to-digital converter (ADC) and/or digital-to-analog converter (DAC) on touch IC 1808.

ACF bonding 1810 may bond antenna trace 1804 to a flexible printed circuit board connector that may further connect antenna trace 1804 to an RFIC. Antenna trace 1804 may be an interdigital type antenna and may boost a coupling with the touch pads (e.g., a transmitting conductive layer such as bottom conductive layer 1604 in FIG. 16) and may increase a radiation efficiency of the overall antenna system (e.g., antenna trace 1804, touch pad 1802, touch sensor traces 1806, etc.)

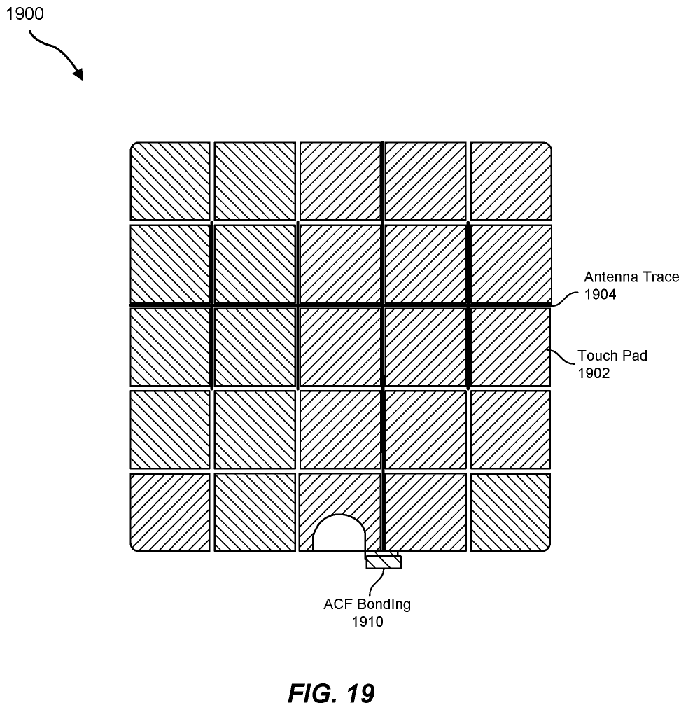

FIG. 19 shows a view of an implementation of a touch sensor film layer 1900 that may be used for antenna radiation. As shown, touch sensor film layer 1900 includes a plurality of touch pads 1902 and an antenna trace 1904. Antenna trace 1904 includes traces that run along gaps between touch pads 1902, giving antenna trace 1904 a “fish bone” shape. ACF bonding 1910 may bond antenna trace 1904 to a flexible printed circuit board connector that may further connect antenna trace 1904 to an RFIC. Although not shown in FIG. 19, touch sensor film layer 1900 may also include touch sensor traces that may be routed along a gap between touch pads 1902 and a bezel of a display stack that includes touch sensor film layer 1900. The touch sensor traces may be connected to a multi-lane ADC/DAC on a touch IC (e.g., touch IC 1808).

The apparatuses, systems, and methods described herein may provide a variety of benefits over conventional options for antennas in wearable devices. By embedding an antenna on a transparent thin film embedded in a display module of a wearable device, the apparatuses, systems, and methods provided herein may enable additional and/or higher quality antennas to be implemented for wearable devices without impacting many space or design requirements for such wearable devices.

In one embodiment, a thin, transparent antenna film may be incorporated into a display stack and attached to cover glass of the display module. In this embodiment, an antenna trace may be designed with a conductive meshed metal (e.g., copper) layer on a transparent film. In an additional embodiment, an existing touch sensor film may be used for antenna radiation. By incorporating a fish bone shaped antenna on the touch sensor film that places antenna traces in gaps between touch pads on the touch sensor film, conductive portions of the touch sensor layer may be concurrently used for antenna radiation as well as touch sensing. Hence, the apparatuses, systems, and methods disclosed herein may provide significant benefits over conventional options for antennas within wearable devices.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 2000 in FIG. 20) or that visually immerses a user in an artificial reality (such as, e.g., virtual-reality system 2100 in FIG. 21). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 20, augmented-reality system 2000 may include an eyewear device 2002 with a frame 2010 configured to hold a left display device 2015(A) and a right display device 2015(B) in front of a user's eyes. Display devices 2015(A) and 2015(B) may act together or independently to present an image or series of images to a user. While augmented-reality system 2000 includes two displays, embodiments of this disclosure may be implemented in augmented-reality systems with a single NED or more than two NEDs.

In some embodiments, augmented-reality system 2000 may include one or more sensors, such as sensor 2040. Sensor 2040 may generate measurement signals in response to motion of augmented-reality system 2000 and may be located on substantially any portion of frame 2010. Sensor 2040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2000 may or may not include sensor 2040 or may include more than one sensor. In embodiments in which sensor 2040 includes an IMU, the IMU may generate calibration data based on measurement signals from sensor 2040. Examples of sensor 2040 may include, without limitation, accelerometers, gyroscopes, magnetometers, other suitable types of sensors that detect motion, sensors used for error correction of the IMU, or some combination thereof.

In some examples, augmented-reality system 2000 may also include a microphone array with a plurality of acoustic transducers 2020(A)-2020(J), referred to collectively as acoustic transducers 2020. Acoustic transducers 2020 may represent transducers that detect air pressure variations induced by sound waves. Each acoustic transducer 2020 may be configured to detect sound and convert the detected sound into an electronic format (e.g., an analog or digital format). The microphone array in FIG. 20 may include, for example, ten acoustic transducers: 2020(A) and 2020(B), which may be designed to be placed inside a corresponding ear of the user, acoustic transducers 2020(C), 2020(D), 2020(E), 2020(F), 2020(G), and 2020(H), which may be positioned at various locations on frame 2010, and/or acoustic transducers 2020(1) and 2020(J), which may be positioned on a corresponding neckband 2005.

In some embodiments, one or more of acoustic transducers 2020(A)-(J) may be used as output transducers (e.g., speakers). For example, acoustic transducers 2020(A) and/or 2020(B) may be earbuds or any other suitable type of headphone or speaker.

The configuration of acoustic transducers 2020 of the microphone array may vary. While augmented-reality system 2000 is shown in FIG. 20 as having ten acoustic transducers 2020, the number of acoustic transducers 2020 may be greater or less than ten. In some embodiments, using higher numbers of acoustic transducers 2020 may increase the amount of audio information collected and/or the sensitivity and accuracy of the audio information. In contrast, using a lower number of acoustic transducers 2020 may decrease the computing power required by an associated controller 2050 to process the collected audio information. In addition, the position of each acoustic transducer 2020 of the microphone array may vary. For example, the position of an acoustic transducer 2020 may include a defined position on the user, a defined coordinate on frame 2010, an orientation associated with each acoustic transducer 2020, or some combination thereof.

Acoustic transducers 2020(A) and 2020(B) may be positioned on different parts of the user's ear, such as behind the pinna, behind the tragus, and/or within the auricle or fossa. Or, there may be additional acoustic transducers 2020 on or surrounding the ear in addition to acoustic transducers 2020 inside the ear canal. Having an acoustic transducer 2020 positioned next to an ear canal of a user may enable the microphone array to collect information on how sounds arrive at the ear canal. By positioning at least two of acoustic transducers 2020 on either side of a user's head (e.g., as binaural microphones), augmented-reality system 2000 may simulate binaural hearing and capture a 3D stereo sound field around about a user's head. In some embodiments, acoustic transducers 2020(A) and 2020(B) may be connected to augmented-reality system 2000 via a wired connection 2030, and in other embodiments acoustic transducers 2020(A) and 2020(B) may be connected to augmented-reality system 2000 via a wireless connection (e.g., a BLUETOOTH connection). In still other embodiments, acoustic transducers 2020(A) and 2020(B) may not be used at all in conjunction with augmented-reality system 2000.

Acoustic transducers 2020 on frame 2010 may be positioned in a variety of different ways, including along the length of the temples, across the bridge, above or below display devices 2015(A) and 2015(B), or some combination thereof. Acoustic transducers 2020 may also be oriented such that the microphone array is able to detect sounds in a wide range of directions surrounding the user wearing the augmented-reality system 2000. In some embodiments, an optimization process may be performed during manufacturing of augmented-reality system 2000 to determine relative positioning of each acoustic transducer 2020 in the microphone array.

In some examples, augmented-reality system 2000 may include or be connected to an external device (e.g., a paired device), such as neckband 2005. Neckband 2005 generally represents any type or form of paired device. Thus, the following discussion of neckband 2005 may also apply to various other paired devices, such as charging cases, smart watches, smart phones, wrist bands, other wearable devices, hand-held controllers, tablet computers, laptop computers, other external compute devices, etc.

As shown, neckband 2005 may be coupled to eyewear device 2002 via one or more connectors. The connectors may be wired or wireless and may include electrical and/or non-electrical (e.g., structural) components. In some cases, eyewear device 2002 and neckband 2005 may operate independently without any wired or wireless connection between them. While FIG. 20 illustrates the components of eyewear device 2002 and neckband 2005 in example locations on eyewear device 2002 and neckband 2005, the components may be located elsewhere and/or distributed differently on eyewear device 2002 and/or neckband 2005. In some embodiments, the components of eyewear device 2002 and neckband 2005 may be located on one or more additional peripheral devices paired with eyewear device 2002, neckband 2005, or some combination thereof.

Pairing external devices, such as neckband 2005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2000 may be provided by a paired device or shared between a paired device and an eyewear device, thus reducing the weight, heat profile, and form factor of the eyewear device overall while still retaining desired functionality. For example, neckband 2005 may allow components that would otherwise be included on an eyewear device to be included in neckband 2005 since users may tolerate a heavier weight load on their shoulders than they would tolerate on their heads. Neckband 2005 may also have a larger surface area over which to diffuse and disperse heat to the ambient environment. Thus, neckband 2005 may allow for greater battery and computation capacity than might otherwise have been possible on a standalone eyewear device. Since weight carried in neckband 2005 may be less invasive to a user than weight carried in eyewear device 2002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2005 may be communicatively coupled with eyewear device 2002 and/or to other devices. These other devices may provide certain functions (e.g., tracking, localizing, depth mapping, processing, storage, etc.) to augmented-reality system 2000. In the embodiment of FIG. 20, neckband 2005 may include two acoustic transducers (e.g., 2020(1) and 2020(J)) that are part of the microphone array (or potentially form their own microphone subarray). Neckband 2005 may also include a controller 2025 and a power source 2035.

Acoustic transducers 2020(1) and 2020(J) of neckband 2005 may be configured to detect sound and convert the detected sound into an electronic format (analog or digital). In the embodiment of FIG. 20, acoustic transducers 2020(1) and 2020(J) may be positioned on neckband 2005, thereby increasing the distance between the neckband acoustic transducers 2020(1) and 2020(J) and other acoustic transducers 2020 positioned on eyewear device 2002. In some cases, increasing the distance between acoustic transducers 2020 of the microphone array may improve the accuracy of beamforming performed via the microphone array. For example, if a sound is detected by acoustic transducers 2020(C) and 2020(D) and the distance between acoustic transducers 2020(C) and 2020(D) is greater than, e.g., the distance between acoustic transducers 2020(D) and 2020(E), the determined source location of the detected sound may be more accurate than if the sound had been detected by acoustic transducers 2020(D) and 2020(E).

Controller 2025 of neckband 2005 may process information generated by the sensors on neckband 2005 and/or augmented-reality system 2000. For example, controller 2025 may process information from the microphone array that describes sounds detected by the microphone array. For each detected sound, controller 2025 may perform a direction-of-arrival (DOA) estimation to estimate a direction from which the detected sound arrived at the microphone array. As the microphone array detects sounds, controller 2025 may populate an audio data set with the information. In embodiments in which augmented-reality system 2000 includes an inertial measurement unit, controller 2025 may compute all inertial and spatial calculations from the IMU located on eyewear device 2002. A connector may convey information between augmented-reality system 2000 and neckband 2005 and between augmented-reality system 2000 and controller 2025. The information may be in the form of optical data, electrical data, wireless data, or any other transmittable data form. Moving the processing of information generated by augmented-reality system 2000 to neckband 2005 may reduce weight and heat in eyewear device 2002, making it more comfortable to the user.

Power source 2035 in neckband 2005 may provide power to eyewear device 2002 and/or to neckband 2005. Power source 2035 may include, without limitation, lithium-ion batteries, lithium-polymer batteries, primary lithium batteries, alkaline batteries, or any other form of power storage. In some cases, power source 2035 may be a wired power source. Including power source 2035 on neckband 2005 instead of on eyewear device 2002 may help better distribute the weight and heat generated by power source 2035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 2100 in FIG. 21, that mostly or completely covers a user's field of view. Virtual-reality system 2100 may include a front rigid body 2102 and a band 2104 shaped to fit around a user's head. Virtual-reality system 2100 may also include output audio transducers 2106(A) and 2106(B). Furthermore, while not shown in FIG. 21, front rigid body 2102 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 2000 and/or virtual-reality system 2100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2000 and/or virtual-reality system 2100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2000 and/or virtual-reality system 2100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The following example embodiments are also included in this disclosure:

Example 1: A system comprising (1) a display cover layer, and (2) a transparent antenna film layer that comprises a film layer comprising at least one antenna, (3) wherein the transparent antenna film layer is positioned between the display cover layer and at least one display layer.

Example 2: The system of example 1, wherein the transparent antenna film layer comprises a printed transparent conductive material.

Example 3: The system of any of examples 1-2, wherein the transparent antenna film layer comprises a meshed metal.

Example 4: The system of example 3, wherein the meshed metal has a pitch of up to 60 μm.

Example 5: The system of any of examples 3-4, wherein the meshed metal has a pitch of at least 60 μm.

Example 6: The system of any of examples 3-5, wherein the meshed metal has a pitch of at least 120 μm.

Example 7: The system of any of examples 1-6, further comprising an adhesive layer and a substrate layer, wherein the transparent antenna film layer is disposed on top of the adhesive layer, which is disposed on top of the substrate layer.

Example 8: The system of any of examples 1-7, further comprising a multi-layer flex that connects a radio frequency (RF) signal from an RF integrated circuit to the transparent antenna film layer.

Example 9: The system of any of examples 1-8, wherein the transparent antenna film layer comprises a multiple input multiple output (MIMO) antenna configuration.

Example 10: A system comprising (1) a conductive touch sensor layer comprising a plurality of touch sensor elements, (2) a substrate layer, and (3) a conductive antenna layer comprising at least one radiating antenna trace, (4) wherein the substrate layer separates the conductive touch sensor layer from the conductive antenna layer, and (5) wherein the at least one radiating antenna trace of the conductive antenna layer is routed between the plurality of touch sensor elements.

Example 11: The system of example 10, further comprising a flex printed circuit to which at least a portion of the substrate layer is bound.

Example 12: The system of example 11, wherein the flex printed circuit electrically connects the conductive touch layer to a touch sensing integrated circuit.

Example 13: The system of any of examples 11-12, wherein the flex printed circuit electrically connects the conductive antenna layer to a radio frequency integrated circuit.

Example 14: The system of any of examples 10-13, wherein the radiating antenna traces of the conductive antenna layer are disposed within one or more gaps between touch sensor elements.

Example 15: The system of any of examples 10-14, wherein the radiating antenna traces of the conductive antenna layer are disposed in a fish bone pattern in one or more gaps between touch sensor elements.

Example 16: The system of any of examples 10-15, wherein the conductive antenna layer comprises a multiple input multiple output (MIMO) antenna configuration.

Example 17: A system comprising (1) a display module included in a wearable device, the display module comprising a display stack, the display stack comprising a display cover layer and a display layer, (2) an antenna layer embedded in the display module of the wearable device and positioned between the display cover layer and the display layer, the antenna layer comprising at least one antenna.

Example 18: The system of 17, wherein the antenna layer comprises a transparent antenna film layer comprising at least one antenna formed of a printed transparent conductive material.

Example 19: The system of example 18, wherein the printed transparent conductive material comprises a meshed metal, a mesh of the meshed metal having a predetermined pitch that renders the transparent antenna layer at least partially transparent to light produced by the display layer.

Example 20: The system of any of examples 17-19, wherein (1) the antenna layer comprises at least one radiating antenna trace, and (2) the display layer comprises a conductive touch sensor layer comprising a plurality of touch sensor elements, (3) wherein the at least one radiating antenna trace is routed between the plurality of touch sensor elements.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
a display cover layer; and
a transparent antenna film layer that comprises a film layer comprising at least one antenna,
wherein the transparent antenna film layer is positioned between the display cover layer and at least one display layer.

2. The system of claim 1, wherein the transparent antenna film layer comprises a printed transparent conductive material.

3. The system of claim 1, wherein the transparent antenna film layer comprises a meshed metal.

4. The system of claim 3, wherein the meshed metal has a pitch of up to 60 μm.

5. The system of claim 3, wherein the meshed metal has a pitch of at least 60 μm.

6. The system of claim 3, wherein the meshed metal has a pitch of at least 120 μm.

7. The system of claim 1, further comprising an adhesive layer and a substrate layer, wherein the transparent antenna film layer is disposed on top of the adhesive layer, which is disposed on top of the substrate layer.

8. The system of claim 1, further comprising a multi-layer flex that connects a radio frequency (RF) signal from an RF integrated circuit to the transparent antenna film layer.

9. The system of claim 1, wherein the transparent antenna film layer comprises a multiple input multiple output (MIMO) antenna configuration.

10. A system comprising:
a conductive touch sensor layer comprising a plurality of touch sensor elements;
a substrate layer; and
a conductive antenna layer comprising at least one radiating antenna trace,
wherein the substrate layer separates the conductive touch sensor layer from the conductive antenna layer, and
wherein the at least one radiating antenna trace of the conductive antenna layer is routed between the plurality of touch sensor elements.

11. The system of claim 10, further comprising a flex printed circuit to which at least a portion of the substrate layer is bound.

12. The system of claim 11, wherein the flex printed circuit electrically connects the conductive touch layer to a touch sensing integrated circuit.

13. The system of claim 11, wherein the flex printed circuit electrically connects the conductive antenna layer to a radio frequency integrated circuit.

14. The system of claim 10, wherein the radiating antenna traces of the conductive antenna layer are disposed within one or more gaps between touch sensor elements.

15. The system of claim 10, wherein the radiating antenna traces of the conductive antenna layer are disposed in a fish bone pattern in one or more gaps between touch sensor elements.

16. The system of claim 10, wherein the conductive antenna layer comprises a multiple input multiple output (MIMO) antenna configuration.

17. A system comprising:
a display module included in a wearable device, the display module comprising a display stack, the display stack comprising a display cover layer and a display layer;
an antenna layer embedded in the display module of the wearable device and positioned between the display cover layer and the display layer, the antenna layer comprising at least one antenna.

18. The system of claim 17, wherein the antenna layer comprises a transparent antenna film layer comprising at least one antenna formed of a printed transparent conductive material.

19. The system of claim 18, wherein the printed transparent conductive material comprises a meshed metal, a mesh of the meshed metal having a predetermined pitch that renders the transparent antenna layer at least partially transparent to light produced by the display layer.

20. The system of claim 17, wherein:
the antenna layer comprises at least one radiating antenna trace; and
the display layer comprises a conductive touch sensor layer comprising a plurality of touch sensor elements;
wherein the at least one radiating antenna trace is routed between the plurality of touch sensor elements.
